(19) United States
(12) Patent Application Publication
(10) Pub. No.: US 2003/0055889 A1
(43) Pub. Date: Mar. 20, 2003

(54) Cache method

(76) Inventors: Meng-Cheng Chen, Taipei (TW); Chi-Fan Ho, Tamsuei (TW)

Correspondence Address: PHILIPS ELECTRONICS NORTH AMERICAN CORP, 580 WHITE PLAINS RD, TARRYTOWN, NY, 10591, US

(21) Appl. No.: 10/227,673

(22) Filed: Aug. 26, 2002

(30) Foreign Application Priority Data
Aug. 27, 2001 (EP) 01203234.8

(51) Int. Cl. G06F 15/16; G06F 15/167

(52) U.S. Cl. 709/203; 709/231; 709/213

(57) ABSTRACT

A method of transmitting update-display data (1) from a thin server device to a thin client device, the method comprising the steps of: generating a (short) key representing new update-display data (1) to be transmitted; comparing a newly generated key to a key or keys previously generated; compiling a message to be transmitted to the client device; the message comprising a header and code words representing the update-display data, wherein the header is set in dependence upon the result of the comparison step to identify to the client whether the update-display data is already cached, to be cached or not to be cached.

Preferably DCT coding is used.

A thin client server system using this method is faster and more efficient.

The present invention relates to a cache method and particularly to a cache method for a thin client server computer system.

A thin client server computer system is one in which computer application programs are installed on a server device but not on a client device. The client device is enabled to run the applications remotely using a thin client display protocol (also known as remote frame buffer technology). The thin client display protocol is a computer program comprising one part loaded onto the server device and another part loaded onto the client device. The client program is a so-called thin program since it has a small code size and thus requires relatively few resources (memory and processing power) of the client device. This system allows relatively simple, inexpensive client devices access to a far more powerful server service.

One such thin client display protocol is Virtual Network Computing (VNC) and comprises a thin server program “VNC server” and a thin client program “VNC viewer” communicating with each other so that the client device forwards commands to the server device which processes the commands and generates updated information, or frame buffer data, in a so-called updated region. This is a basic unit necessary for screen update on the client device. It may take the form of a window. The updated region is forwarded from the server device to the thin client device. Effectively the display side of the protocol instructs the client device to put a rectangle of pixel data at a given x,y position on the client screen.

A problem with thin client server computer systems is that there is a considerable amount of data being transferred between the server and the client devices and this can result in delays in the system, particularly in the client device retrieving data from the server device.

More efficient transmission of frame buffer data from a thin server to a thin client has been achieved using different coding algorithms for different data patterns, and also by object aware cache methods such as is described in “Independent Computing Architecture Technical Paper” by Citrix Systems, Mar. 16, 1996 and Adaptive Internet Protocol. However, these methods are software platform dependent and thus cannot be universally adopted without modification depending upon the operating systems being run on the computers. Non object aware protocols such as VNC are preferred.

Cache methods have been proposed for more efficient communication between devices in internet environments but these cannot easily be applied to thin client server systems, because the characteristics of the internet and of thin client server computer systems are totally different. For example, caching at proxy servers reduces the perceived response time for access to the World Wide Web. They select subsets of documents for caching but extra steps must be taken to maintain consistency of the cached documents.

It is an object of the present invention to improve the efficiency of a thin client server computer system and to speed up data transfer. The invention is defined by the independent claims; the dependent claims define advantageous embodiments.

Preferably the message comprises a header which comprises a cache instruction field containing an instruction corresponding to one of the commands “cache”, “no cache”, “cached” and a sequence identity field comprising a cache address, such as the address of the matching key or a new address as appropriate.

The key comprises the combined length of the code words of compressed coded update-display data. Compression coding is preferably by Discrete Cosine Transform (DCT), especially 2D-DCT, which transfers the data from space domain to frequency domain.

One embodiment further comprises quantising the data, eg by JPEG encoding and entropy coding.

According to a preferred embodiment of the invention the size, eg the dimensions of height and width, of the encoded data is checked and no caching is done if the size is less than a predetermined level. Size can also be used as a preliminary comparison step. If correspondence between keys is found then the locally cached data is displayed by the client device. If more than one correspondence is found then code words are compared. If data has been lost from the client device it may send a re-transmit message back to the server device.

The invention can provide a convenient, fast and relatively cost effective way of filtering out non-candidate regions, with the comparison being done in the server and intra-frame coding being used for each updated region to simplify computation.

For a better understanding of the present invention, and to show how the same may be carried into effect, reference will now be made to the accompanying drawings, in which:

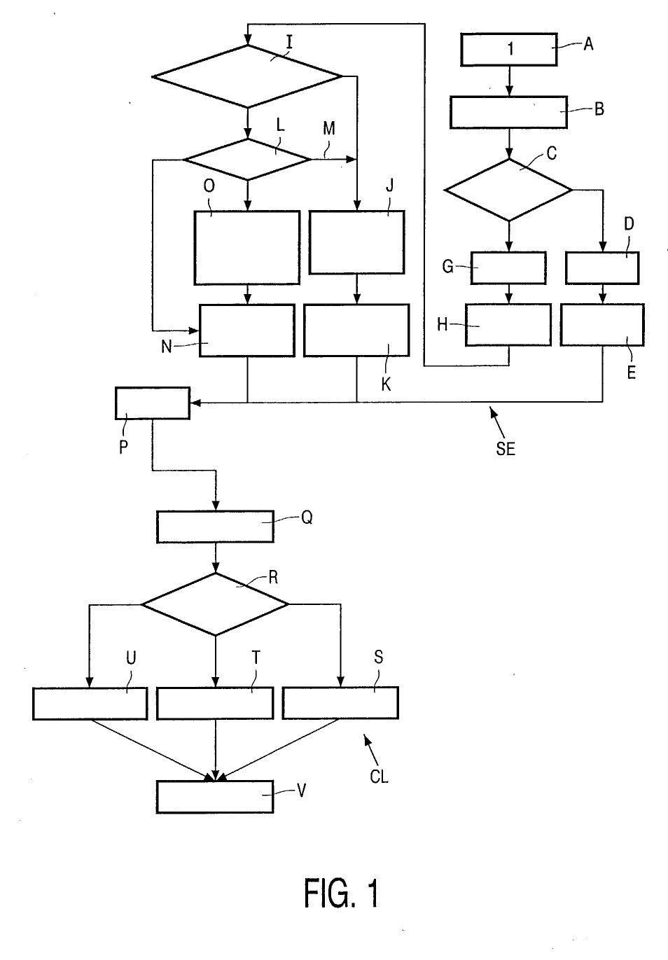

FIG. 1 is a flow chart of the method of the present invention as applied to a server and a client of a thin client server system;

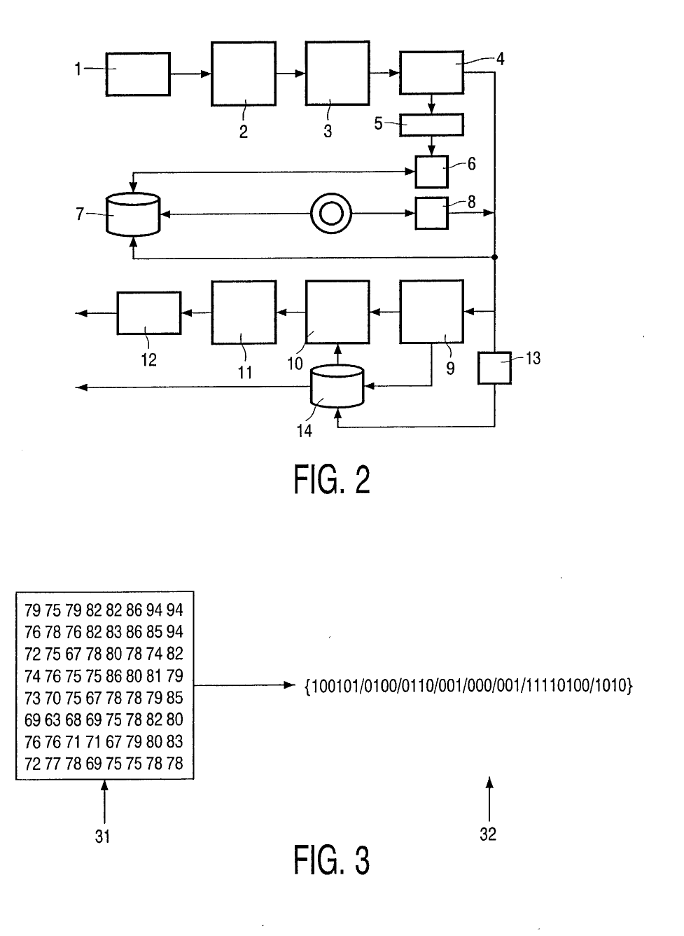

FIG. 2 is a flow chart illustrating the method of generating a region key for the method of FIG. 1;

FIG. 3 is a schematic example of compression of a data block in the generation of the region key of FIG. 2;

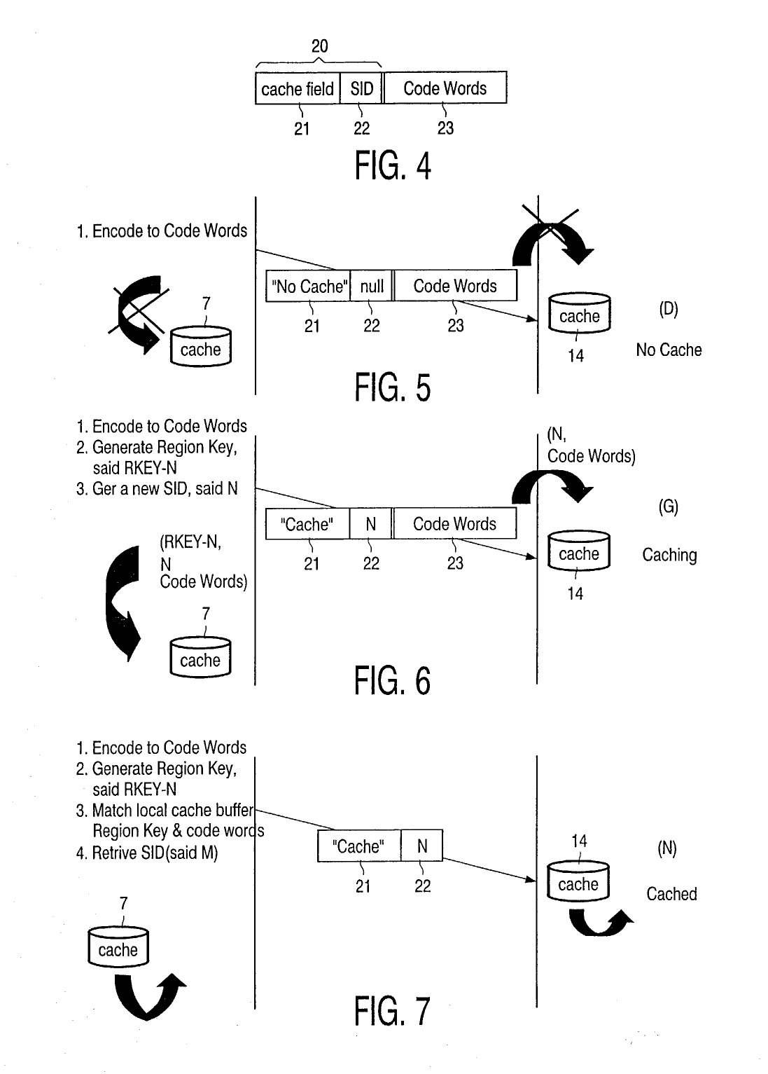

FIG. 4 shows a message format for use with the method of FIGS. 1 to 3;

FIG. 5 illustrates part of the method of the present invention for a first case;

FIG. 6 illustrates part of the method of the present invention for a second case;

FIG. 7 illustrates part of the method of the present invention for a third case;

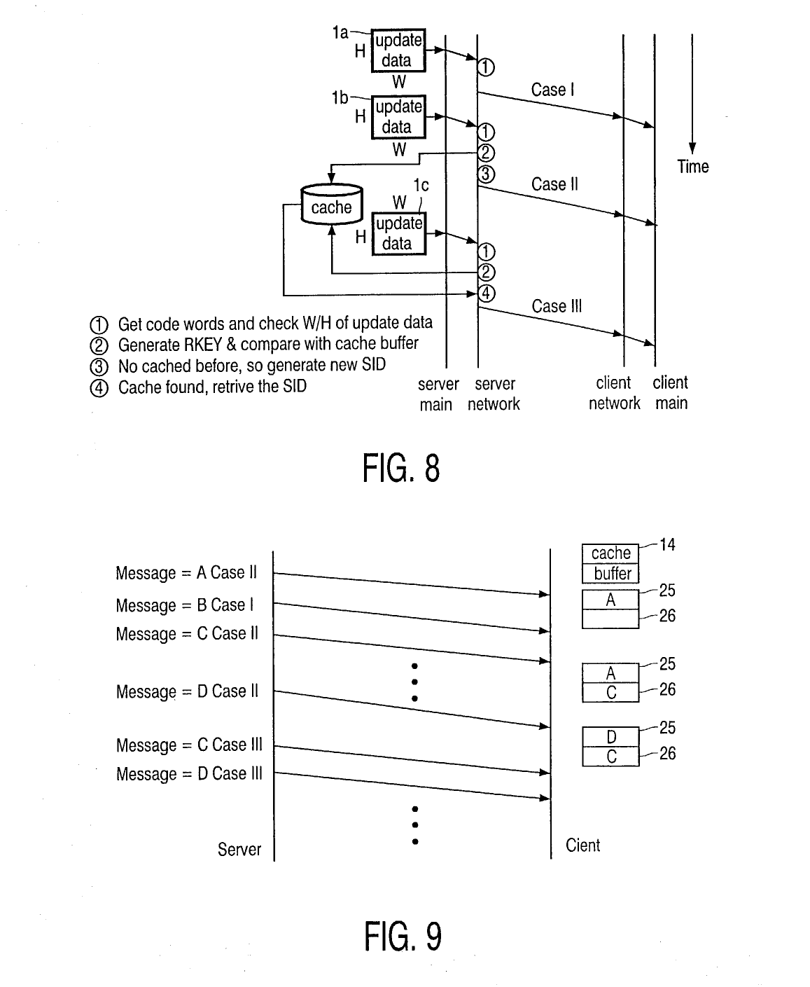

FIG. 8 illustrates an example of the method of the invention.

FIG. 9 illustrates another example of the method of the invention.

In the flow chart of FIG. 1 a thin server program is running. This is a typically “VNC server” but other similar programs would also be effective. The following steps take place: In the server SE:

A. The update-display data or updated region has a height H and a width W and is represented as source data 1.

B. The source data 1 is encoded to generate code words, as will be described with reference to FIGS. 2 and 3.

C. The encoded source data is checked for width and height.

D. If the width and height are less than a threshold value then the cache field of a message header is set to “No cache” (There is no benefit to be gained from caching if the update is very small.).

This situation is illustrated in FIG. 5 which will be described later.

E. The sequence identity SID is set to NULL and the updated message is then sent to the client—see step P described below.

G. If the width and height are more than a threshold value then the cache field of the message header is set to “cache”

This situation is illustrated in FIG. 6 described below.

H. The region key RKEY representing the data/image signatures is generated using the method described in relation to FIG. 2 below, by combining the length of the code words

I. The server then checks whether any updated regions have been cached before, and whether the cached regions width and height match the updated regions.

J. If no updated region has been cached before then the server will obtain the next available sequence identity SID, and it will format the message to be sent to the client by setting the SID field in the message header accordingly, and setting the cache field of the message header to “cache”.

K. The server maintains a copy of the message (comprising the SID, RKEY and the code words of compressed data) and transfers the message to the client -see step P below.

L. If an updated region has been cached before then the server will recognise this when it checks the RKEY for a matching cached one.

M. If no matching region key RKEY is identified then step J is repeated, and a new message is sent to the client with the compressed data representing the updated region.

N. If only one match is found then the cache field is set to “cached” and the corresponding SID is sent to the client without the code words of compressed data.

This is illustrated in FIG. 7 to be described below.

O. If more than one region key RKEY match is found then the new code words of compressed data are compared with the code words in the local cache buffer and when matching code words are identified then the cache field is set to “cached” and the corresponding SID without code words of compressed data is sent.

P. The message is sent from the server.

In the client CL:

Q. The message is received by the client.

R. The client first checks the cache field of the message to determine whether to cache this updated region or not.

S. If the cache field is set to “cache” the client maintains a copy of the code words of the updated region and decodes the code words and moves to step V.

T. If the cache field is set to “no cache” the client decodes the code words in the message but does not save it and moves to step V

U. If the cache field is set to “cached” the client retrieves the cached code words from the client cache and decodes the code words and moves to step V

V. The decoded updated region is displayed.

In the upper part of FIG. 2 generation of the region key 6 from updated region source data 1 is shown using coding, and the lower part of FIG. 2 shows subsequent decoding of the encoded data. The source data 1, ie data or image representing the updated region signature, is compressed by a Forward Discrete Cosine Transform FDCT 2 and quantised at 3. It is then entropy encoded at 4 and the length of the code words are combined at 5 to generate key 6. This is then copied to the cache memory 7 of the server and the sequence identity indicator 8 is incremented by one. This is shown in the top part of FIG. 1.

In due course the data is decoded, by entropy decoding at 9, de-quantising at 10, and decompressing at 11 to form decoded data 12. A sequence generator 13 is incremented each time to point to a different location of the cache 14.

FIG. 3 shows coding of an original source image data which is grouped into a block 31 comprising a grid of 64 two digit numbers in an 8×8 grid. A forward DCT process is applied to decompress the block into 64 orthogonal signals (called DCT coefficients). One coefficient has zero frequency in both dimensions and this is called the DC coefficient. The other 63 are AC coefficients. After discarding visually insignificant information and quantising and entropy processing the result is a compressed codeword 32 comprising a string of binary words with a total of 35 bits. In this example using 8 bit compression for the source image the compression rate is about 15:1

FIG. 4 represents the format of a message for transmission from the server to the client. It has a message header 20 formed of a cache field 21 (“cache”, “no cache” or “cached”) and a sequence identity field SID 22. It also has a message field 23 comprising the code words of the compressed message.

FIG. 5 illustrates the make up of the message of FIG. 4 in the case when the server instructs “no cache”. This may occur for example when the dimensions of the updated region are below a threshold so that it is not worth caching. The cache field 21 is set for “no cache” and the SID field 22 is set to “null” in the header, and the compressed code words are attached in message field 23.

FIG. 6 illustrates the make up of the message of FIG. 4 in the case when the server instructs “cache”.

This occurs when the dimensions of the updated region are above the threshold. The cache 21 field is set for “cache” and the SID field 22 is set to “N” in the header, and the compressed code words are attached in message field 23.

FIG. 7 illustrates the make up of the message of FIG. 4 in the case when the server instructs “cached”.

In this case the message header 20 comprises the instruction “cached” in the cache field 21 and “M” in the SID field 22 and the compressed code words are not attached since in this situation they can be retrieved from the local cache at the client device, thus saving transmission band-width between the server and the client and improving speed and efficiency of the system.

FIG. 8 illustrates how the system reacts over a time line to each of the cases represented by FIGS. 5 to 7.

The first updated region data 1 a is generated in the server device and in \mathring{1} the dimensions are below the threshold and the server instructs “no cache”. A message as illustrated in FIG. 5 is generated and transmitted to the client device over a computer network and accordingly the updated region is displayed on the client display. This is labelled case I.

A short time later second updated region data 1b is generated. The dimensions of the updated region 1b are above the threshold and a region key RKEY is generated and compared with the contents cache buffer (7 see FIG. 2) of the server. This is shown as \mathring{2}. At \mathring{3} there was no cache before and so the message “cache” is sent to the client with the data. This is labelled as case II. At \mathring{4} the corresponding key is found in cache 7. The SID is retrieved and the message “cached” is transmitted to the client device in a message with the appropriate SID but without the data, so as to save transmission space and time. This is labelled as case III.

The SID numbers will typically cycle from 1 to 999 to save memory space while ensuring that the most recent updated region data is stored.

If only two cache buffers are available then the situation of FIG. 9 applies and the circulated list is maintained to cache the most recent 2 updated regions. For example message A is a case II message: “cache” (because there was no previous cache). Thus the cache buffer 14 stores A in first cache location 25. Message B is then generated and this is a case I message: “no cache”, so no store of B is made and second cache location 26 is empty. Message C is another case II message: “cache”, and so now C is stored in cache location 26. Message D is likewise case II and D therefore replaces A in location 25.

Subsequently message C is received again and this is a case III message “cached” because the server detects correspondence with a cached message C. Thus the message to the client device includes the SID for location 26 to retrieve the corresponding data from local cache 14. Likewise when message D is retransmitted, correspondence is found and the case III message instructs the client to retrieve the data from local cache buffer 14 at location 25.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of transmitting update-display data from a thin server device to a thin client device, the method comprising the steps of:
generating a key (6) representing new update-display data (1) to be transmitted;
comparing a newly generated key to a key or keys previously generated; and
compiling a message to be transmitted to the client device,
wherein the message is set in dependence upon the result of the comparison step to identify to the client device whether the update-display data (1) is already cached, to be cached or not to be cached.

2. A method according to claim 1, wherein the message comprises a header (20) which comprises a cache instruction field (21) and a sequence identity field (22).

3. A method according to claim 2, wherein the cache instruction field contains an instruction corresponding to one of the commands: “cache”, “no cache” and “cached”, and the sequence identity field (22) comprises a cache address.

4. A method according to claim 3, wherein the cache address is the address of the matching key when the command is “cached”.

5. A method according to claim 3, wherein the cache address is a new address when the command is “cache”.

6. A method according to claim 1, wherein the key is generated by transform coding of the update-display data (1).

7. A method according to claim 6, wherein the key comprises the combined length of all code words of the encoded update-display data (1).

8. A method according to claim 2, further comprising the initial step of checking the size of the update-display data (1) and setting the cache instruction field to “no cache” if the size of the update-display data (1) is less than a predetermined value.

9. A method according to claim 1, wherein the comparison step further comprises first comparing the size of the new update-display data (1) to the size of cached update-display data.

10. A method according to claim 8,wherein the size of the update-display data (1) comprises a width and a height of the data (1).

11. A method according to claim 1, further comprising the step of comparing code words of new update-display data (1) with cached update-display data if more than one matching key is identified in the cache data.

12. A method according to claim 2, wherein the client device sends a transmit code word message to the server if the sequence identity field (22) flags data lost from the client memory.

13. A thin client server computer system adapted for performing the method of claim 1.

14. Computer software for enabling a processor to carry out the method of claim 1.

15. A data carrier comprising the computer software according to claim 14.

16. A computer system comprising a server device having:
a cache memory;
a sequence identity generator to identify cache memory addresses;
a source data encoder;
a key generator for generating a key representing encoded source data;
a comparator for comparing a generated key to one or more cached keys;
a message generator linked to the comparator for generating different messages depending upon the output of the comparator;
a transmitter for sending the message to a client device;
the client device having:
a receiver for receiving the message from the server;
a cache memory;
a message reader; and
a display.
